(19) United States
(12) Patent Application Publication
(10) Pub. No.: US 2025/0120379 A1
(43) Pub. Date: Apr. 17, 2025

(54) ELECTRIC FISHING REEL

(71) Applicant: GLOBERIDE, Inc., Tokyo (JP)

(72) Inventor: Issei MIYAMOTO, Higashikurume-shi (JP)

(73) Assignee: GLOBERIDE, Inc., Tokyo (JP)

(21) Appl. No.: 18/762,861

(22) Filed: Jul. 3, 2024

(30) Foreign Application Priority Data
Oct. 16, 2023 (JP) 2023-178002

(51) Int. Cl. A01K 89/017

(52) U.S. Cl. CPC A01K 89/017

(57) ABSTRACT

An electric fishing reel of the present invention comprises a drive motor that is provided in a frame of a reel main body and rotationally drives a spool around which a fishing line is wound. The motor case houses a motor component of the drive motor and constitutes an external component and is formed separately from the frame, and the frame fits and supports the motor case.

### CROSS-REFERENCE TO RELATED APPLICATION

This application claims priority under 35 U.S.C. § 119 to Japanese Patent Application No. 2023-178002 filed on Oct. 16, 2023 in the Japanese Patent Office, the entire contents of each hereby incorporated by reference.

### BACKGROUND OF THE INVENTION

### 1. Technical Field

The present invention relates to an electric fishing reel in which a fishing line is wound around a spool by an output from a drive motor supported on a reel main body.

### 2. Description of the Related Art

Normally, as disclosed in JP 2010-51272 A, for example, an electric fishing reel has a structure in which a spool is rotationally driven by driving of a drive motor supported by a frame of a reel main body to wind a fishing line. The output from the drive motor is decelerated via a deceleration mechanism such as a planetary gear mechanism and transmitted to a drive shaft of the spool. Further, the drive motor is housed in a motor case integrally formed with a frame, and a set plate supporting a planetary gear mechanism, a bearing component, and the like constituting the deceleration mechanism is attached to the frame.

### SUMMARY OF THE INVENTION

As described above, by integrally forming the motor case with the frame, an inner diameter of a portion housing motor components can be maximized, and the motor output can be improved. In addition, since the frame and the motor case are integrated, the accuracy of the output shaft of the motor can be easily obtained.

When integrating the motor case with the frame at low cost, it is necessary to simultaneously mold the motor case and the frame structure by resin molding or a die casting method. However, in such a method, due to convenience of the mold such as strength and durability, an excess portion is generated, and the weight of the entire reel increases. In addition, since the motor case and the frame are integrated, if the molding and processing steps of the frame are not completed, the motor components cannot be incorporated, and a delay occurs in the entire production process.

The present invention has been made in view of the above problems, and an object thereof is to provide an electric fishing reel that can reduce the weight of a reel main body and has high production efficiency.

In order to achieve the above object, an electric fishing reel according to the present invention comprises a drive motor that is provided in a frame of a reel main body and rotationally drives a spool around which a fishing line is wound, and a motor case houses a motor component of the drive motor and constitutes an external component and is formed separately from the frame, in which the frame fits and supports the motor case.

In the above-described electric fishing reel, since the motor case that houses the motor component of the drive motor constitutes an external component and is formed separately from the frame, production processes of the motor case and the frame are separated from each other, and efficiency of the production processes can be improved. In addition, since the frame (frame without a motor case) having a small excess thickness can be formed by a die casting method, the weight of the entire reel can be reduced. Furthermore, since the motor case housing the motor component is attached to the frame and becomes an external component as it is, the configuration can be simplified and the weight can be reduced, and since the motor case is a member separate from the frame, a free material can be selected.

According to the present invention, it is possible to reduce the weight of a reel main body and to obtain an electric fishing reel with high production efficiency.

### BRIEF DESCRIPTION OF THE DRAWINGS

FIG. 1 is a perspective view illustrating an embodiment of an electric fishing reel according to the present invention;

FIG. 2 is a perspective view of the electric fishing reel illustrated in FIG. 1 as viewed obliquely from the front, with a left cover removed;

FIG. 3A is a side view illustrating a fixed state of a motor case that is a component of a drive motor, and FIG. 3B is a perspective view of a main part;

FIG. 4 is a perspective view of a schematic configuration of a frame constituting a reel main body and a set plate attached to the frame as viewed from a front side;

FIG. 5A is a side view of the frame, and FIG. 5B is a rear view of the frame;

FIG. 6A is a plan view of the frame, and FIG. 6B is a front view of the frame;

FIG. 7 is a perspective view illustrating a configuration of the set plate;

FIG. 8 is a perspective view illustrating a state in which the motor case is incorporated in the set plate; and

FIG. 9 is a cross-sectional view taken along an output shaft portion of the drive motor, illustrating a fixed state of the frame and the motor case.

### DETAILED DESCRIPTION

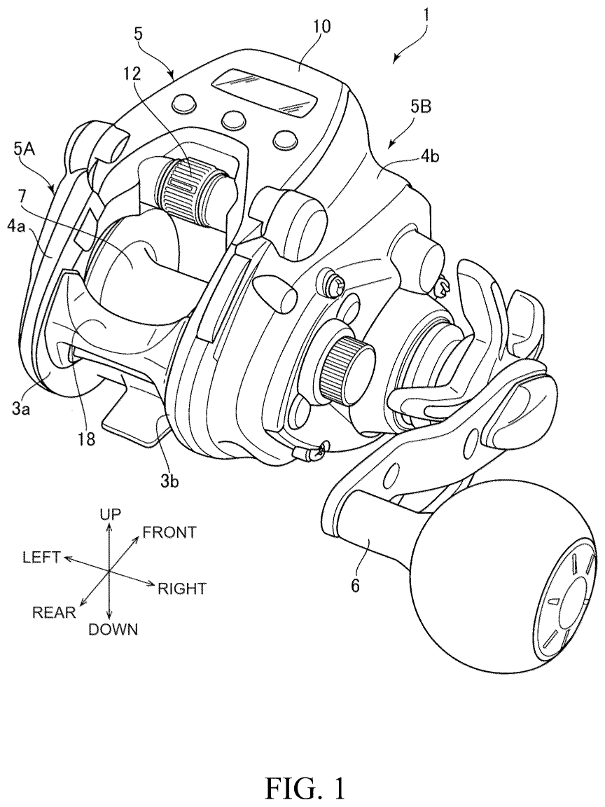

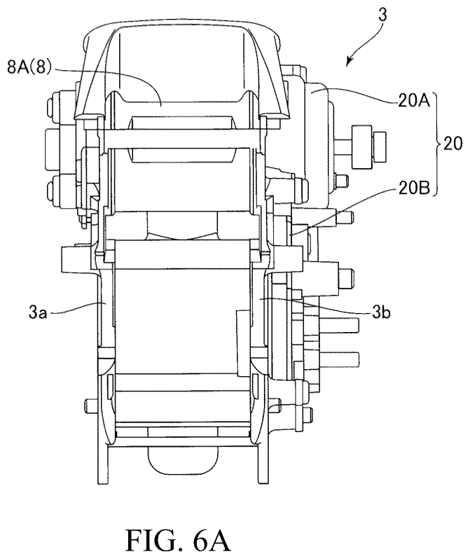

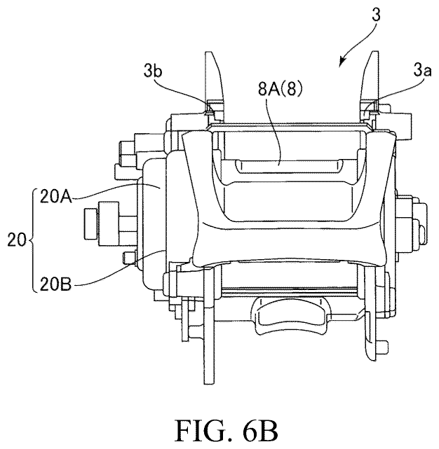

Hereinafter, an embodiment of an electric fishing reel according to the present invention will be described with reference to FIGS. 1 to 9. Note that, in the following description, a front-rear direction, a left-right direction, and an up-down direction are defined as the directions illustrated in FIG. 1, the front-rear direction is defined as an axial direction of a fishing rod when the fishing rod is attached, the left-right direction is defined as an axial direction of an output shaft of a drive motor, and the up-down direction is defined as a direction orthogonal to the front-rear direction and the left-right direction.

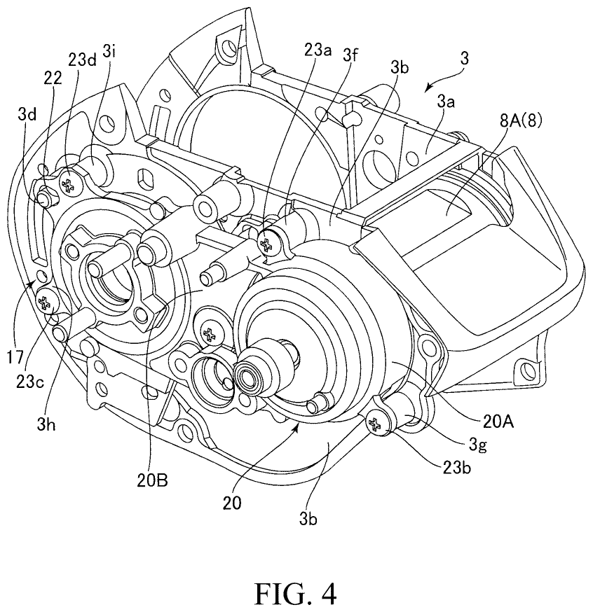

As illustrated in FIGS. 1 to 6B, an electric fishing reel 1 according to the present embodiment comprises a reel main body 5 comprising left and right side plates 5A and 5B constituted by attaching left and right covers 4a and 4b to left and right frames 3a and 3b. As illustrated in FIGS. 4 to 6B, the left and right frames 3a and 3b are connected in the left-right direction to form an integrated structure (the integrated structure is also referred to as a frame 3).

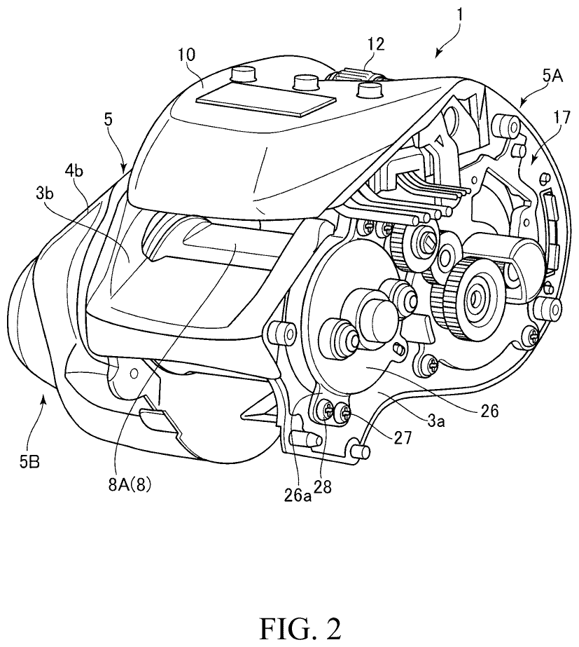

A manual handle 6 to be wound is provided on one side plate (right side plate 5B) side constituting the reel main body 5, and a spool 7 around which a fishing line is wound is rotatably supported between the left and right side plates 5A and 5B. Further, in the present embodiment, the drive motor 8 is held between the left and right frames 3a and 3b on a front side of the spool 7 (FIGS. 2 to 6B). The spool 7 is rotationally driven in a fishing line winding direction by a winding operation of the manual handle 6 and the rotational drive of the drive motor 8. Note that although the drive motor 8 may be installed inside the spool 7, by installing the drive motor 8 in front of the spool 7 as in the present embodiment, the reel main body 5 can be made as compact as possible while ensuring a line winding amount of the spool 7.

A box-shaped control case 10 housing a control unit that controls the drive motor 8 is disposed above the spool 7 between the left and right side plates 5A and 5B. Further, an operation member 12 that adjusts output of the drive motor 8 is disposed in a rear portion of the control case 10. The operation member 12 of the present embodiment has a dial form provided on a support shaft rotatably supported behind the control case 10, and is configured to adjust the output of the drive motor by rotating the operation member 12 in the front-rear direction.

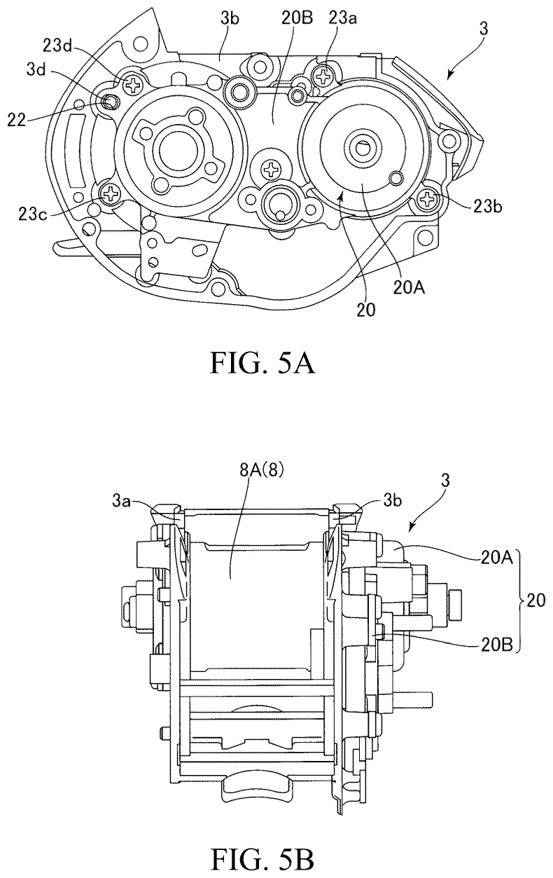

Further, in the frame 3 (the right frame 3b in the present embodiment), a known clutch mechanism 17 (FIGS. 4, 5A, and 5B) that switches the spool 7 to the fishing line winding state/free rotation state is disposed. The clutch mechanism 17 has a function of connecting and disconnecting power transmission from the manual handle 6 and the drive motor 8 to the spool 7, and is configured to switch from a clutch-ON state to a clutch-OFF state by a clutch operation member 18 disposed on the rear side of the spool 7 so as to be displaceable in the up-down direction. That is, when the clutch operation member 18 is pushed down in the clutch-ON state (power transmission state) illustrated in FIG. 1, the state is switched to the clutch-OFF state.

Note that returning from the clutch-OFF state to the clutch-ON state can be automatically performed by a winding operation of the manual handle 6, driving of the drive motor 8, or the like.

A set plate 20 to be described later is disposed between the right frame 3b and the right cover 4b. An engagement hole 22 is formed on a rear end side of the set plate 20, and provides a proof by fitting the engagement hole 22 on a protrusion 3d formed in the right frame 3b, and in this state, a plurality of screws 23a to 23d is screwed from the outside into screw holes (which may be screw holes formed in bosses) 3f to 3i formed in the right frame 3b in this state, thereby fixing the set plate 20 non-rotationally to the right frame 3b.

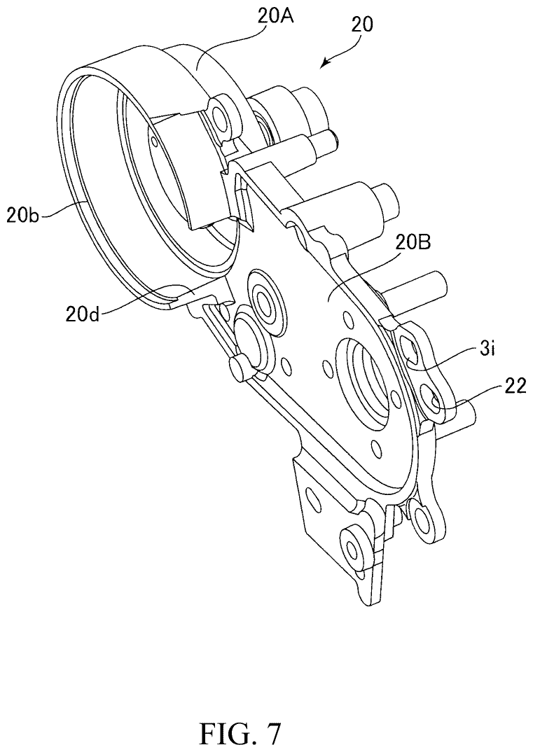

Next, configurations of the drive motor 8 and the set plate 20 will be described with reference to FIGS. 7 to 9. As is known, the drive motor 8 comprises motor components such as a magnet forming a magnetic field along a circumferential direction, an armature having a coil wound so as to face the magnet, and a commutator attached to an end of the output shaft 8a, and these motor components are housed on a radially inner side of a motor case 8A formed in a substantially cylindrical shape.

The motor case 8A is open on both sides in the axial direction, the right frame side is closed by the set plate 20, and the left frame side is closed by a lid member 26 fixed to the left frame 3a. Further, the output from the output shaft 8a of the drive motor 8 is decelerated by a deceleration mechanism 30 installed on the right frame side and transmitted to the spool 7 via a driving force transmission mechanism 40.

Further, the motor case 8A is not integrally formed with the frame 3, but is formed in a cylindrical shape as a member different from the frame by using, for example, metal such as aluminum, titanium, or magnesium, resin, FRP, or the like. That is, the motor case can be formed by a material different from the material of the frame 3, and the output shaft 8a and the motor components such as a magnet, an armature, and a commutator as described above are mounted inside such a motor case.

As described above, since the motor case 8A of the drive motor 8 is formed separately from the frame 3, the motor case 8A can be individually created without being affected by the delivery state of the frame 3 as in the conventional case, and the entire production process is not delayed. In addition, since the motor case 8A does not have a surplus portion generated by being integrally formed with the frame and a material can be freely selected, effects such as weight reduction (thickness reduction) and reduction in frictional force can be obtained. Further, as illustrated in FIG. 2, the motor case has an external component whose external appearance can be grasped, and thus it is possible to improve designability such as adding colors and patterns.

The set plate 20 houses the deceleration mechanism 30 on the right frame side and supports gears 41 and 42 constituting the driving force transmission mechanism 40, a bearing component 50, and the like. That is, the set plate 20 of the present embodiment comprises a housing part 20A that houses the deceleration mechanism 30 provided on the output shaft 8a of the drive motor 8, and a gear support portion 20B that supports the gears 41 and 42 constituting the driving force transmission mechanism.

The housing part 20A is formed in a substantially cylindrical shape bulging in the axial direction with respect to the gear support portion 20B, and the deceleration mechanism 30 is housed in an internal space thereof. As is known, the deceleration mechanism 30 of the present embodiment comprises a planetary gear mechanism (two stages) attached to the output shaft 8a of the drive motor 8, and comprises sun gears 31a and 31b attached to the output shaft 8a, planetary gears 32a and 32b meshing with sun gears 31a and 31b, and an internal gear 33 comprising the internal teeth 33a meshing with planetary gears 32a and 32b. External teeth 33b are formed on an outer peripheral surface of the internal gear 33, and rotational driving decelerated by the deceleration mechanism 30 is output to the gears 41 and 42 constituting the driving force transmission mechanism 40 via the external teeth 33b.

Normally, since the side plate (the cover) is an external component and often has a curved surface, the deceleration mechanism 30 and the driving force transmission mechanism 40 cannot be fixed and disposed at appropriate positions only with the side plate. On the other hand, by disposing the set plate 20 as described above, the deceleration mechanism 30 and the driving force transmission mechanism 40 can be disposed at appropriate positions, and the ease of incorporation and maintainability can be improved. In addition, by providing the bulging housing part 20A that houses the deceleration mechanism 30 in the set plate 20, the width direction of the reel main body can be made compact.

The motor case 8A and the set plate 20 have a fitting structure in which the motor case 8A is fitted to the set plate 20. That is, the motor case 8A is configured to be fitted to the set plate 20 instead of supporting the motor case on the frame and fixing the set plate to the frame as in the conventional case.

As described above, by fitting the motor case 8A to the set plate 20, it is possible to reduce the cumulative tolerance from the motor case to the frame and from the frame to the set plate as in the related art, and it becomes easy to make the output shaft 8a of the drive motor 8 coaxial with the deceleration mechanism 30, the bearing component, and the like, and it is possible to suppress a decrease in the motor output.

In the fitting structure in the present embodiment, a protrusion 8b is formed on the motor case 8A side, and a recess 20b into which the protrusion 8b can be fitted is formed on the set plate 20 side. In this case, since the motor case 8A is formed in a cylindrical shape having a substantially circular cross section centered on the output shaft 8a, the protrusion 8b is formed in an annular shape in which an outer end edge having a maximum diameter extends in the axial direction. In addition, the recess 20b on the set plate 20 side is constituted by an annular groove extending in the axial direction on an inner surface of an inner front edge so that the housing part 20A can be formed in a similar circular shape and the protrusion 8b formed in an annular shape can be fitted.

Specifically, the fitting structure of the present embodiment comprises an outer peripheral surface of the annular protrusion 8b and an inner peripheral surface of the annular recess 20b, and both the protrusion 8b and the recess 20b are formed in a circular shape centered on the output shaft 8a of the drive motor 8.

According to such a circular fitting structure, since the orbit of the deceleration mechanism 30 such as a planetary gear connected to the output shaft 8a is circular, it is possible to obtain a fitting structure in which a minimum space required for rotation is secured. In addition, since the fitting portion is the annular protrusion formed at the radially outer end of the end portion of the motor case 8A, it is easy to be incorporated into the recess 20b, and since the fitting is performed at the position of the maximum diameter, a stable fixed state can be obtained without backlash.

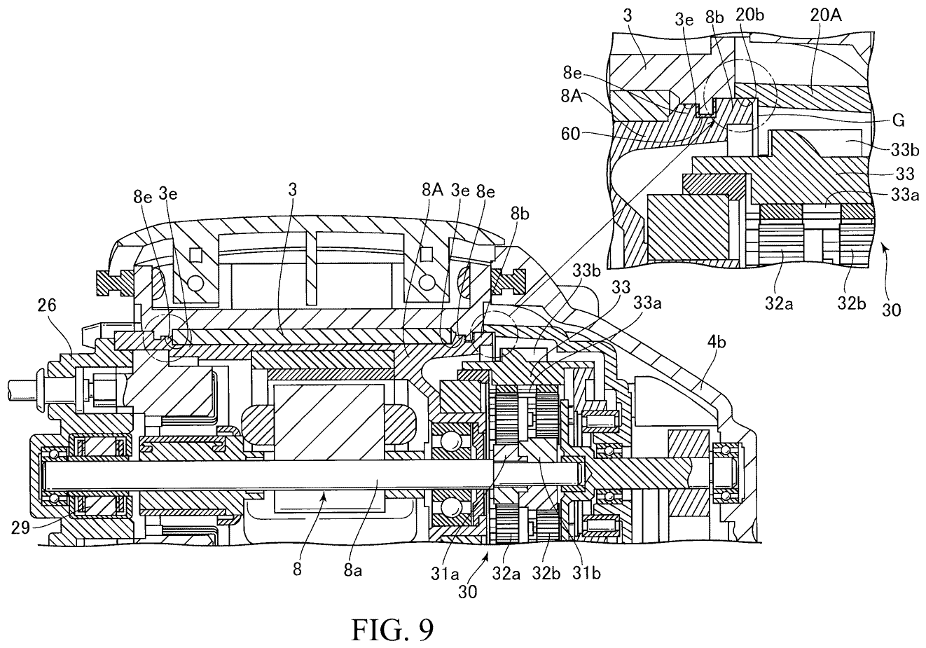

In this case, in the present embodiment, as illustrated in FIG. 9, a gap (escape portion) G is formed between the axial end surface of the protrusion 8b and a receiving surface of the recess 20b of the housing part 20A. As illustrated in FIGS. 5A and 5B, the set plate 20 is fixed to the right frame 3b on the reference plane by screwing the plurality of screws 23a to 23d from the outside. At this time, if the protrusion 8b and the recess 20b are received in the circumferential direction and the axial direction, it is possible that the protrusion 8b and the recess 20b are not fixed well in relation to some components such as a deceleration mechanism.

By providing the gap G as described above and receiving the protrusion 8b and the recess 20b along the circumferential direction without being in contact with each other in the axial direction, the set plate 20 can be stably fixed.

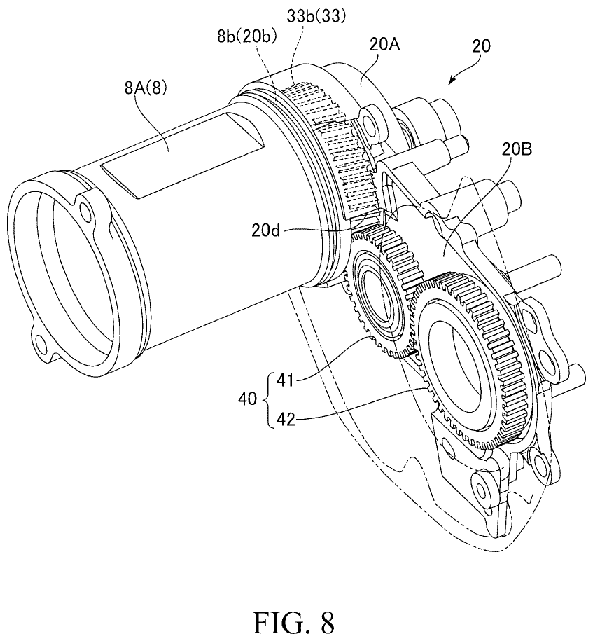

Note that, in the present embodiment, since the internal gear 33 that outputs power to the outside is disposed in the housing part 20A, an arc-shaped notch portion 20d is formed on an outer peripheral surface of the housing part 20A so that the external teeth 33b and the gear 41 can mesh with each other (FIGS. 7 and 8).

Further, the protrusion 8b formed in the motor case 8A in the present embodiment serves as an assembly proof for positioning the set plate 20 attached to the frame 3. That is, as illustrated in FIG. 9, in the present embodiment, the protrusion 8b of the motor case 8A protrudes axially outward from the frame 3, and serves as an assembly proof of the set plate 20 with respect to the frame 3.

As described above, since the motor case 8A also serves as an assembly proof for positioning the set plate 20 with respect to the frame 3, it is not necessary to separately provide a boss or the like to position the set plate 20 on the frame 3, and the internal structure can be simplified to achieve miniaturization and weight reduction.

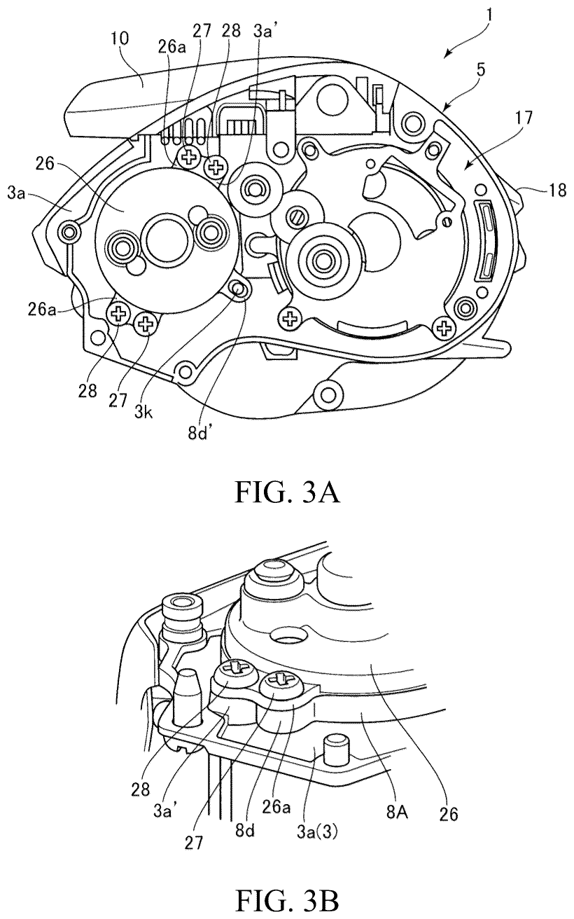

The opening on the left frame side of the motor case 8A is closed by the lid member 26 fixed to the left frame 3a. As illustrated in FIG. 3B, an end on the left frame side of the motor case 8A protrudes in the axial direction from the surface of the left frame 3a, and the opening on the left side of the motor case 8A is closed and fixed by abutting and fixing the lid member 26 on the axial end surface of this protruding portion.

That is, the lid member 26 is fixed to the motor case 8A (the opening on the left frame side of the motor case 8A is closed) by forming a plurality of projecting pieces 8d in the circumferential direction of the motor case 8A, forming a protrusion 26a protruding in the radial direction at a corresponding position in the lid member 26, and screwing the screws 27 from the outside with the screw holes provided in both aligned.

It is preferable that the lid member 26 closes the opening of the motor case 8A and is positioned and fixed in the axial direction and the rotational direction with respect to the right frame 3a. For example, as illustrated in FIG. 3A, the lid member 26 can be prevented from rotating with respect to the right frame 3a by forming a projecting piece 8d′ in which a through hole penetrating in the axial direction is formed in the lid member 26 and fitting the through hole into a boss 3k formed in the frame 3a. Further, as illustrated in FIG. 3B, a boss portion 3a′ is provided in the frame 3a adjacent to the plurality of projecting pieces 8d, and a screw 28 is screwed in the boss portion 3a′ from the outside, whereby the lid member 26 can be fixed to the right frame 3a in the axial direction.

In this manner, by forming the protrusion 26a on the outer periphery of the lid member 26 and using this portion, the lid member 26 that closes the opening of the motor case 8A can be prevented from rotating with respect to the left frame 3a, and can be configured not to be displaced in the axial direction. Note that, as is known, a one-way clutch 29 that rotatably supports the output shaft 8a in one direction is disposed inside the lid member 26 so that the manual handle does not rotate together when the drive motor 8 is driven.

The motor case 8A described above has motor components mounted therein and is supported with respect to the frame 3 so as to be external components. In the present embodiment, as described above, the motor case 8A is formed in a cylindrical shape with both ends opened, and the right frame side is closed by the set plate 20 and protrudes axially outward from the right frame 3b to form an assembly proof of the set plate 20 with respect to the frame 3. Further, the opening on the left frame side of the motor case 8A is closed by the lid member 26 and fixed to the left frame 3a.

In such a configuration, a fitting portion for fitting and supporting the motor case 8A and the frame 3 is provided so that the motor case 8A and the frame 3 can be stably fixed to the frame 3, and the motor case 8A and the frame 3 are formed to be integrated into a fitting structure. In this case, for example, it is preferable that each of the frame 3 and the motor case 8A is provided with a pair of fitting portions that fits and supports the frame and the motor case on both end sides in the axial direction, and according to such a fitting support structure, the motor case 8A is not in a cantilevered support state and can be stably supported.

As illustrated in FIG. 9, the fitting portions of the present embodiment comprise an arc-shaped protrusion 8e formed along the circumferential direction on both end sides of the outer peripheral surface of the motor case 8A, and an arc-shaped recessed groove 3e that is formed at a corresponding position of the frame 3 and into which the protrusion 8e of the motor case 8A is fitted.

Thus, on the motor case 8A, protrusions are formed at two positions spaced apart in the axial direction, and the recessed groove 3e into which the protrusion 8e is to be fitted is formed in the frame 3 to correspond thereto, so that the motor case 8A can be stably held and the accuracy of the output shaft 8a can be improved. In addition, since the portion to be fitted and supported is the outer peripheral surface of the motor case 8A, the motor case portion does not become long in the axial direction, the lateral width can be suppressed, and the main body 5 can be downsized.

Note that, in the above configuration, a waterproof packing 60 is preferably provided in the fitting portion between the motor case 8A and the frame 3 (in FIG. 9, it is disposed only in the fitting portion on the right frame side, but it is also disposed in the fitting portion on the left frame side in the same manner). By providing the waterproof packing 60 in the fitting portion between the two in this manner, it is possible to prevent seawater or the like from entering the inside. Further, the fitting portions may be configured so that a recessed groove is formed on the outer peripheral surface of the motor case 8A, and a protrusion to be fitted with the recessed groove is provided at a corresponding position on the frame 3 side.

The embodiment of the present invention has been described above; however, the present invention is not limited to the above-described embodiment, and can be modified in various forms. For example, the motor case 8A and the frame 3 may be fitted and supported at two or more portions, and the formed portion can be appropriately deformed.

The fitting structure between the motor case 8A and the set plate 20 may be configured so that a recess is formed on the motor case side and a protrusion is formed on the set plate side, or may be configured so that the inner peripheral surface of the protrusion 8b of the motor case 8A is fitted to the outer peripheral surface of the housing part 20A of the set plate 20.

Further, as long as the driving force transmission mechanism 40 supported by the set plate 20 has a function of transmitting a rotational driving force of the drive motor 8 to the spool 7 side, various changes can be made, for example, transmitting power by a transmission belt or the like. Further, the set plate 20 and the manual handle 6 described above may be disposed on the left side plate side. Further, the clutch mechanism can be variously changed.

What is claimed is:

1. An electric fishing reel comprising a drive motor that is provided in a frame of a reel main body and rotationally drives a spool around which a fishing line is wound, the electric fishing reel comprising:
a motor case that houses a motor component of the drive motor and constitutes an external component and is formed separately from the frame, wherein
the frame fits and supports the motor case.

2. The electric fishing reel according to claim 1, wherein the frame and the motor case are provided with a pair of fitting portions that fits and supports the frame and the motor case on both ends in an axial direction.

3. The electric fishing reel according to claim 1, wherein the fitting portion comprises a protrusion or a recess formed along a circumferential direction on both end sides of an outer peripheral surface of the motor case, and a recess or a protrusion formed at a corresponding position of the frame and into which the protrusion or the recess of the motor case is fitted.

4. The electric fishing reel according to claim 3, wherein the fitting portion has a gap between the protrusion and the recess, and is received along the circumferential direction without being in contact with each other in the axial direction.

5. The electric fishing reel according to claim 3, wherein a waterproof fit is provided in the fitting portion.
